(19) United States
(12) Patent Application Publication
(10) Pub. No.: US 2024/0332814 A1
(43) Pub. Date: Oct. 3, 2024

(54) RECONFIGURABLE METASURFACE ANTENNA

(71) Applicants: EXPIKX CO., LTD., Seoul (KR); CENTER FOR ADVANCED META-MATERIALS, Daejeon (KR)

(72) Inventors: Jong Ho CHOE, Seoul (KR); Q Han PARK, Seoul (KR); Jin Soo KIM, Seoul (KR)

(21) Appl. No.: 18/741,083

(22) Filed: Jun. 12, 2024

Related U.S. Application Data
(63) Continuation of application No. PCT/KR2022/020421, filed on Dec. 15, 2022.

(30) Foreign Application Priority Data
Dec. 16, 2021 (KR) 10-2021-0180351
Mar. 11, 2022 (KR) 10-2022-0030378

(51) Int. Cl. H01Q 15/00; H01Q 1/38; H01Q 1/46

(52) U.S. Cl. CPC H01Q 15/0086; H01Q 1/38; H01Q 1/46

(57) ABSTRACT

Disclosed is a reconfigurable metasurface antenna. The reconfigurable metasurface antenna includes: a power feeding unit receiving and propagating electromagnetic waves in the form of a concentric wave; and a variable metasurface unit positioned at an upper part of the power feeding unit, having a plurality of unit radiators, and radiating the electromagnetic waves transmitted from the power feeding unit according to a combination of activated unit radiators among the plurality of unit radiators to have different phase and polarization components.

### CROSS-REFERENCE TO RELATED APPLICATION

This application is a bypass continuation of pending PCT International Application No. PCT/KR2022/020421, which was filed on Dec. 15, 2022, and which claims priority to Korean Patent Application No. 10-2021-0180351 which was filed in the Korean Intellectual Property Office on Dec. 16, 2021, and Korean Patent Application No. 10-2022-0030378 which was filed in the Korean Intellectual Property Office on Mar. 11, 2022. The disclosures of which are hereby incorporated by reference in their entireties.

### TECHNICAL FIELD

The present disclosure relates to a reconfigurable metasurface antenna.

### BACKGROUND ART

For efficient transmission and reception of electromagnetic waves, an orientation direction should be able to be effectively controlled by considering a radiation pattern of an antenna. In particular, antenna beam steering performance is very important in communication with artificial satellites located far from the ground. There are two main methods for controlling the electromagnetic wave beam steering direction of the antenna: \textcircled{1} directly moving the antenna mechanically using a motor, etc. to aim the antenna in a desired direction, or \textcircled{2} modulating the wavefront of the electromagnetic wave radiated from the antenna surface so that the electromagnetic wave can be steered in the desired direction. In the latter case, there is no need to directly move the antenna, and a representative technology that implements this is phased array antenna technology.

The phased array antennas form a wavefront of a desired shape by radiating electromagnetic waves of different phases and sizes from multiple radiators on the surface. At this time, the intensity of the radiated electromagnetic wave and the steering direction vary depending on the wavefront formed, which is determined by the number of radiators, the phase range of the electromagnetic wave that each radiator can modulate, and the intensity of the electromagnetic wave. The phased array antenna basically feeds electromagnetic waves of the same size and phase to all radiators on the antenna surface. After modulating the phase, the phase is amplified to an appropriate size to form the wavefront of the steering beam.

Meanwhile, metamaterial/metasurface technologies that relatively freely control electromagnetic waves in a desired form have recently emerged and are developing. As this technology is applied to the antenna field, it is being developed into holographic antenna technology, and is showing many possibilities as the corresponding technology is combined with variable circuits. The most recent advanced beam steering antenna is an antenna utilizing a reconfigurable metasurface, which is similar to the phased array antenna in that the reconfigurable metasurface antenna modulates the wavefront of the antenna surface to steer the beam in the desired direction, but the specific wavefront modulation method is different. In the case of the phased array antenna, electromagnetic waves of the same phase and size are fed to each radiator, but the reconfigurable metasurface antenna is fed spatially like a normal leaky wave antenna. Since the size and phase of electromagnetic waves fed to individual radiators are all different, the beam is controlled by operating only the radiators that can create a beam steering wavefront in the desired direction.

In the current representative reconfigurable metasurface antenna for satellite communication, each radiator of the metasurface contains liquid crystals, and the liquid crystal operates variably according to electrical signals to turn on or off the radiator. An antenna gain and steering angle range are suitable for use in satellite communication, but because the liquid crystal is used, the operating speed is very slow, at the ms level. Because of this slow operation speed, there are many situations in which the reconfigurable metasurface antenna cannot be used.

### DISCLOSURE

### Technical Problem

The present disclosure is to provide a reconfigurable metasurface antenna.

Further, the present disclosure is to provide a reconfigurable metasurface antenna capable of free beam steering without using a phase modulator or RF amplifier.

Further, the present disclosure is to provide a reconfigurable metasurface antenna capable of free electromagnetic wave beam steering while overcoming the shortcomings of a phased array antenna technology using a method different from the phased array antenna technology without using a mechanical drive unit.

In addition, the present disclosure is to provide a reconfigurable metasurface antenna that has improved problems such as a slow operation speed and manufacturing complexity by applying a circuit method that is relatively easy to manufacture instead of a liquid crystal used in the existing reconfigurable metasurface antenna.

### Technical Solution

According to an aspect of the present disclosure, provided is a reconfigurable metasurface antenna.

According to an embodiment of the present disclosure, a reconfigurable metasurface antenna may be provided, which includes: a power feeding unit receiving electromagnetic waves and propagating the electromagnetic waves in the form of a concentric wave; and a variable metasurface unit positioned at an upper part of the power feeding unit, having a plurality of unit radiators, and radiating the electromagnetic waves transmitted from the power feeding unit according to a combination of activated unit radiators among the plurality of unit radiators to have different phase and polarization components.

The plurality of unit radiators may be formed in a circular ring shape, a metal slot shape, a metal I-shape slot shape, and a circular metal slot shape, respectively, or formed in different shapes or in a combination of the shapes, and each of the plurality of unit radiators may be formed on the top or the bottom of the variable metasurface unit. Further, the plurality of unit radiators may also be formed in different shapes, and also formed in different sizes, respectively.

Each of the plurality of unit radiators may include at least one active electronic device, and the active electronic device may be formed on the same surface as or an opposite surface to a bias line, and when the active electronic device is formed on the opposite surface, each unit radiator may be connected to the bias line through a via hole.

When the plurality of unit radiators are formed in the circular ring shape, an inner center separated by the circular ring shape may be connected to the outside by the active electronic device, and a via hole for transmitting an electrical signal for controlling whether the plurality of unit radiators are activated may be formed at the inner center of the plurality of unit radiators.

A plurality of bias lines may be formed on the top of the variable metasurface unit, and one end of each bias line may be connected to each unit radiator through the via hole.

A portion of each bias line connected to each unit radiator through the via hole may be formed perpendicular to a virtual direction line of each unit radiator.

The virtual direction line is a virtual line connecting the center of the variable metasurface unit and the via hole of each unit radiator.

The other end of each bias line may be connected to a connector applying the electrical signal, and whether each unit radiator is activated may be determined by the electrical signal applied through the bias line.

Locations of the plurality of unit radiators may be determined by the following equation,

$$x = \sqrt{i} \times ( ratio ) \times {λ}_{0} \times cos ( {α}_{g} \times i ) \\ y = \sqrt{i} \times ( ratio ) \times {λ}_{0} \times sin ( {α}_{g} \times i )$$

wherein, i represents the index of each unit radiator, α_{g} represents a golden angle (π(3−\sqrt{5})≈137.5°), λ₀ represents the center frequency wavelength, a ratio represents the ratio to the spacing distance between each unit radiator.

The power feeding unit may have a lower space and an upper space partitioned by a separator formed therein, or have a single space forming a single plane without the separator, and when the inside is partitioned into the lower space and the upper space by the separator, a waveguide coupler receiving the electromagnetic waves may be positioned at the center of the lower space, and an RF absorber absorbing the electromagnetic waves may be positioned at the center of the upper space, wherein the electromagnetic waves may be reflected to the upper space from the lower space, and the electromagnetic waves may be propagated to the lower space from the upper space.

When the power feeding unit has the single space without the separator, the waveguide coupler receiving the electromagnetic waves is positioned at the center of the internal space and the electromagnetic waves which spread outward while forming the concentric circle from the center are formed, and an absorber absorbing the electromagnetic waves which spread outward while forming the concentric circle may be positioned to surround an antenna outside the waveguide.

### Advantageous Effects

A reconfigurable metasurface antenna according to an embodiment of the present disclosure is provided to be capable of free electromagnetic wave beam steering while overcoming the shortcomings of a phased array antenna technology using a method different from the phased array antenna technology without using a mechanical drive unit.

Further, it is possible to improve problems such as a slow operation speed and manufacturing complexity by applying a circuit method that is relatively easy to manufacture instead of a liquid crystal used in the existing reconfigurable metasurface antenna.

In addition, the present disclosure has a simpler structure than a conventional antenna, which has the advantages of easy maintenance, low manufacturing cost, and fast operation speed.

### BRIEF DESCRIPTION OF DRAWINGS

FIG. 1 is a diagram showing a reconfigurable metasurface antenna according to an embodiment of the present disclosure.

FIG. 2 is a side view of the reconfigurable metasurface antenna according to an embodiment of the present disclosure.

FIG. 3 is a top view of the reconfigurable metasurface antenna according to an embodiment of the present disclosure.

FIG. 4 is a bottom view of the reconfigurable metasurface antenna according to an embodiment of the present disclosure.

FIG. 5 is a cross-sectional view of a reconfigurable metasurface antenna according to a first embodiment of the present disclosure.

FIG. 6 is a bottom view of a variable metasurface unit according to the first embodiment of the present disclosure.

FIG. 7 is an enlarged view of a unit radiator of FIG. 6.

FIG. 8 is a top view of the variable metasurface unit according to the first embodiment of the present disclosure.

FIG. 9 is an enlarged view of a part of a bias line of FIG. 8.

FIG. 10 is a cross-sectional view of a reconfigurable metasurface antenna according to a second embodiment of the present disclosure.

FIG. 11 is a top view of a variable metasurface unit according to the second embodiment of the present disclosure.

FIG. 12 is a bottom view of the variable metasurface unit according to the second embodiment of the present disclosure.

FIG. 13 is a top view of the variable metasurface unit according to a third embodiment of the present disclosure.

FIG. 14 is a bottom view of the variable metasurface unit according to the third embodiment of the present disclosure.

FIG. 15 is a cross-sectional view of a reconfigurable metasurface antenna according to a fourth embodiment of the present disclosure.

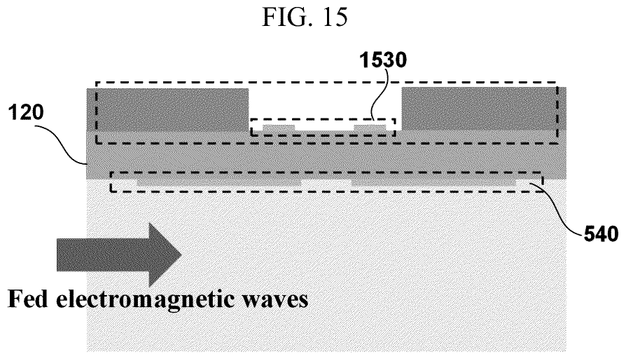

FIG. 16 is a top view of a variable metasurface unit according to the fourth embodiment of the present disclosure.

FIG. 17 is a bottom view of the variable metasurface unit according to the fourth embodiment of the present disclosure.

FIG. 18 is a top view of a variable metasurface unit according to a fifth embodiment of the present disclosure.

FIG. 19 is a bottom view of the variable metasurface unit according to the fifth embodiment of the present disclosure.

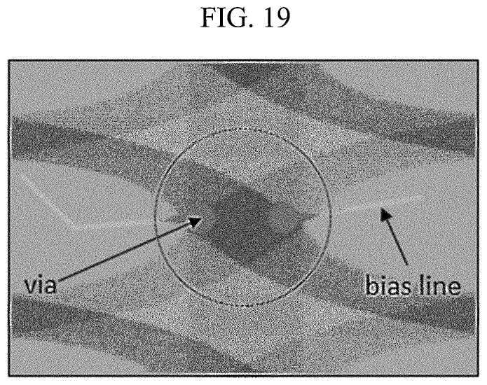

FIG. 20 is a diagram showing a beam steering result which varies depending on a switching state of a reconfigurable metasurface antenna according to an embodiment of the present disclosure.

### BEST MODE

In the present specification, singular forms include plural forms unless the context clearly indicates otherwise. In the specification, the terms “comprising” or “including,” and the like are not to be construed as necessarily including several components or several steps described in the specification, and are to be construed that some of the above components or steps may not be included, or additional components or steps may be further included. In addition, the terms “ . . . unit,” “module,” and the like described in the specification refer to a processing unit of at least one function or operation and may be implemented by hardware or software or a combination of hardware and software.

Hereinafter, exemplary embodiments of the present disclosure will be described in detail with reference to the accompanying drawings.

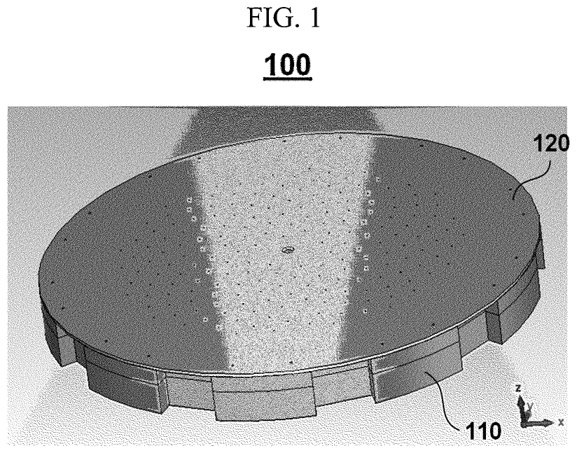

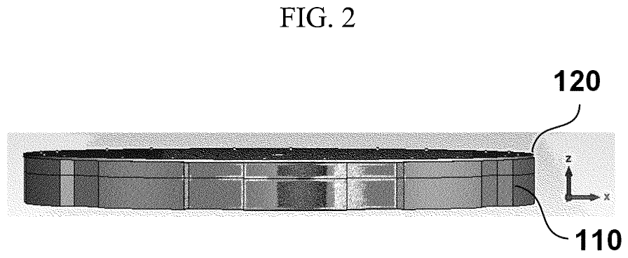

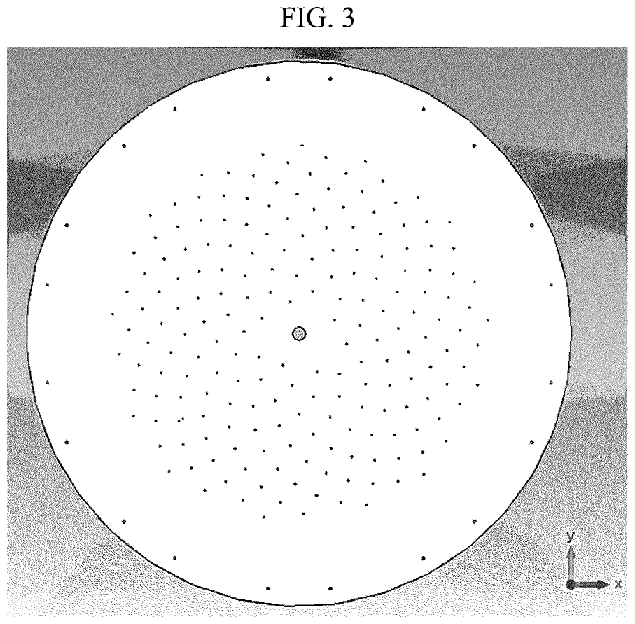

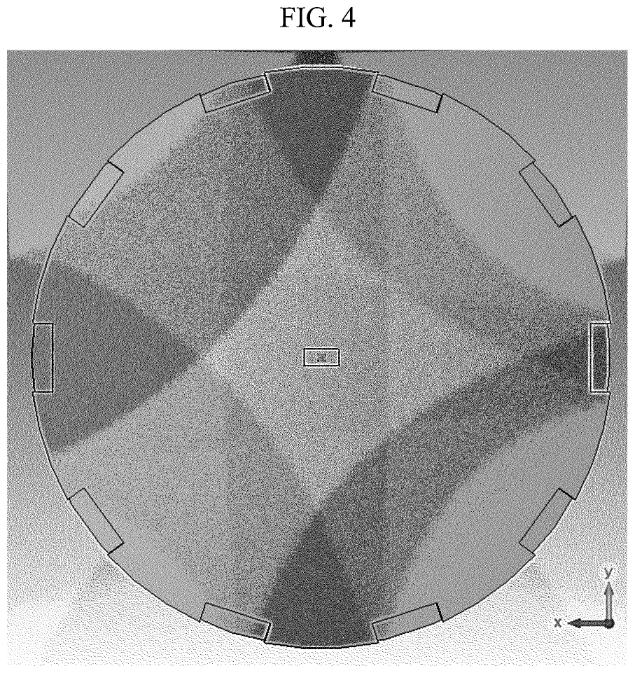

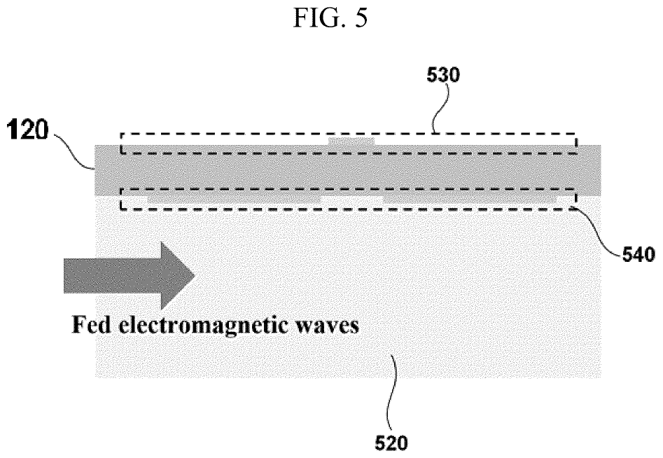

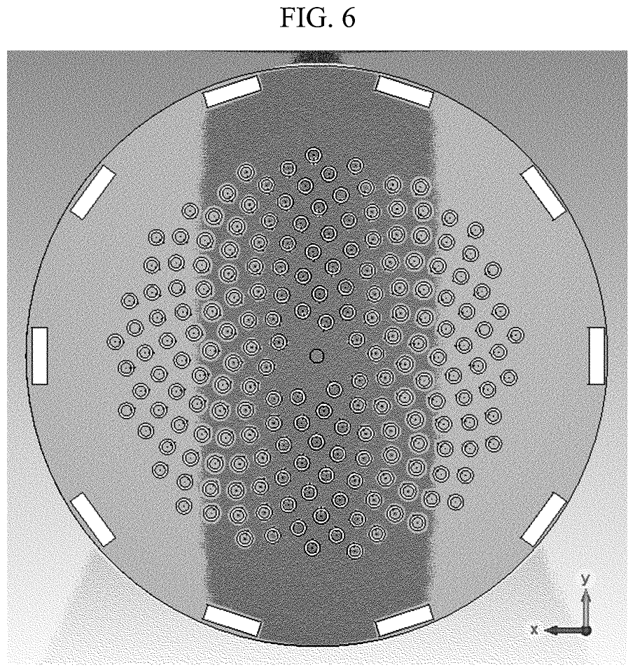

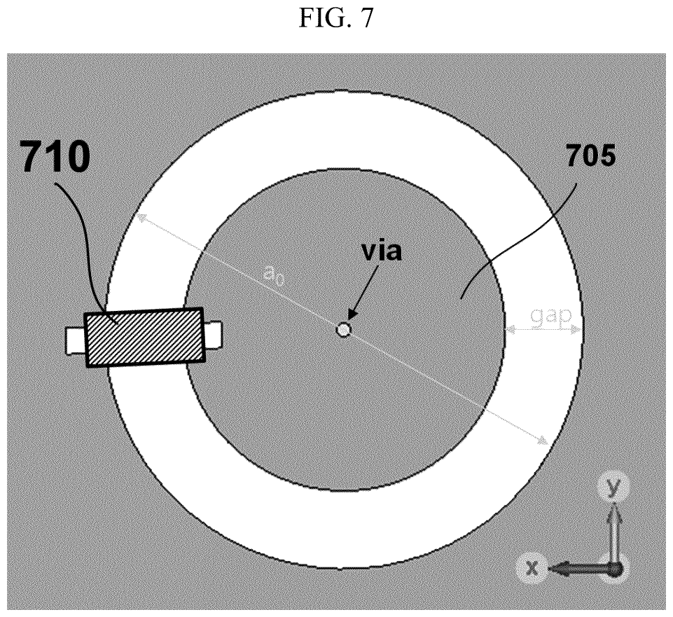

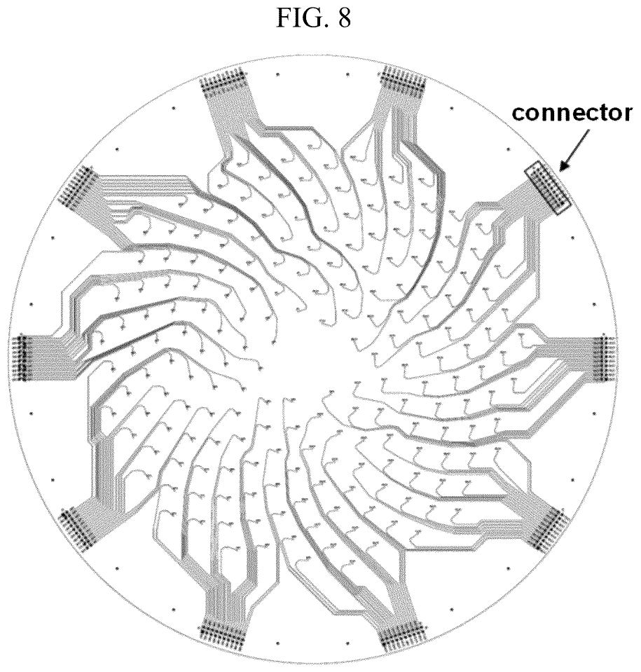

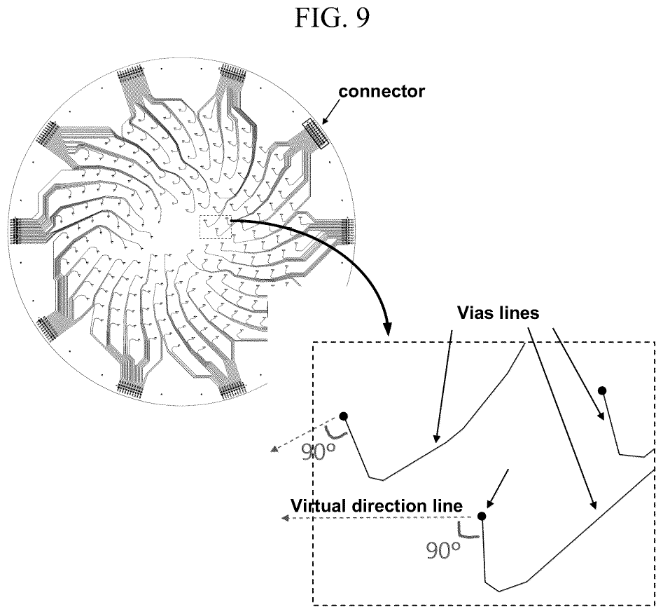

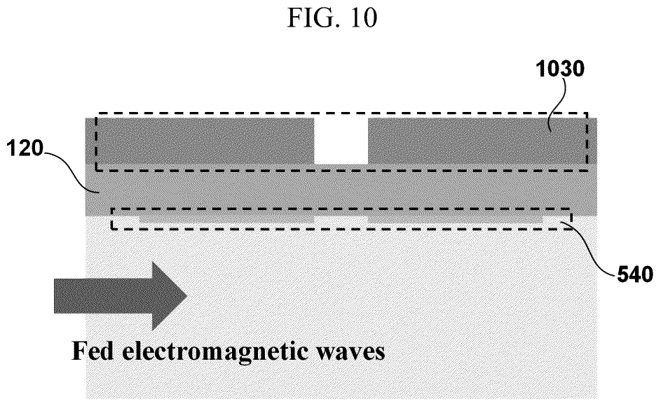

FIG. 1 is a diagram showing a reconfigurable metasurface antenna according to an embodiment of the present disclosure, FIG. 2 is a side view of the reconfigurable metasurface antenna according to an embodiment of the present disclosure, FIG. 3 is a top view of the reconfigurable metasurface antenna according to an embodiment of the present disclosure, FIG. 4 is a bottom view of the reconfigurable metasurface antenna according to an embodiment of the present disclosure, FIG. 5 is a cross-sectional view of a reconfigurable metasurface antenna according to an embodiment of the present disclosure, FIG. 6 is a bottom view of a variable metasurface unit according to an embodiment of the present disclosure, FIG. 7 is an enlarged view of a unit radiator of FIG. 6, FIG. 8 is a top view of the variable metasurface unit according to an embodiment of the present disclosure, FIG. 9 is an enlarged view of a part of a bias line of FIG. 8, and FIG. 10 is a diagram showing a beam steering result which varies depending on a switching state of the reconfigurable metasurface antenna according to an embodiment of the present disclosure.

Referring to FIG. 1, the reconfigurable metasurface antenna 100 according to an embodiment of the present disclosure is configured to include a power feeding unit 110 and a variable meta surface unit 120.

As illustrated in FIGS. 1 and 2, the power feeding unit 110 and the variable metasurface unit 120 may be disposed in a structure that contacts each other. That is, the reconfigurable metasurface antenna may be formed so that a top of the power feeding unit 110 and a bottom of the variable metasurface unit 120 contact each other.

As illustrated in FIGS. 1 to 4, the reconfigurable metasurface antenna according to an embodiment of the present disclosure may be formed in a circular shape. This is just an example, and in addition to the circular shape, the reconfigurable metasurface antenna may also be formed in other shapes depending on an implementation method.

The power feeding unit 110 is a means for receiving an electromagnetic wave signal radiated through the reconfigurable metasurface antenna 100 and transmitting the electromagnetic wave signal to the variable metasurface unit 120 located at the top. That is, the power feeding unit 110 may receive an electromagnetic wave signal to be radiated to an antenna through a cable and then transmit the electromagnetic wave in the form of a concentric wave to the variable metasurface unit 120.

The power feeding unit 110 may receive the electromagnetic wave signal from the center of the reconfigurable metasurface antenna 100, and then propagate the electromagnetic wave signal to the outside in a concentric wave shape, and reflect the propagated electromagnetic wave signal on a side wall, and then propagate the reflected electromagnetic wave signal to an upper space again. In transmitting the electromagnetic wave to the variable metasurface unit 120, the power feeding unit 110 may transmit the electromagnetic wave in a two-layer structure.

The structure for this will be described below in brief. The power feeding unit 110 may be partitioned into a lower space and an upper space. Here, the lower space and the upper space may be divided by a separator located inside the power feeding unit 110.

A waveguide coupler for receiving the electromagnetic wave may be located in the lower space of the power feeding unit 110, and an RF absorber may be located in the upper space. The waveguide coupler and the RF absorber may be located at the center of the power feeding unit 110, respectively.

The waveguide coupler located in the lower space of the power feeding unit 110 may be connected to the cable to receive the electromagnetic wave signal, and then propagate the electromagnetic wave signal outward from the center of the lower space. As such, the propagated electromagnetic wave may be reflected on the side wall of the power feeding unit 110 and transmitted to the upper space partitioned by the separator, and the electromagnetic wave transmitted to the upper space may be propagated from the outside back to the center, and collected into the RF absorber.

Since the waveguide coupler is located at the center of the lower space, and the power feeding unit 110 itself (i.e., reconfigurable metasurface antenna) is formed in the circular shape, the electromagnetic wave propagated from the waveguide power feeding unit 110 may be propagated from the center toward the outside of the power feeding unit 110 in the form of a concentric wave.

The electromagnetic wave propagated outward from the lower space of the power feeding 110 may be reflected on the upper space by an inner reflection unit located on the outer periphery of the lower space. In order to reflect the electromagnetic wave from the lower space of the power feeding unit 110 to the upper space, a portion of the inner reflection unit may be formed to be inclined at a predetermined angle. A portion of the inner reflection unit may be inclined at a predetermined angle, and the remaining portion may be formed perpendicular to the bottom surface of the lower space so as to be parallel to the side wall.

In addition, the inner reflection unit may also be formed on the outer periphery of the upper space of the power feeding unit 110. The inner reflection unit of the upper space may be formed in an inclined form so that a portion of the upper portion has an inclination of a predetermined angle.

The electromagnetic wave reflected on the upper space of the power feeding unit 110 is propagated in the form of the concentric wave from the outside of the power feeding unit 110 to the center, and collected toward the RF absorber formed in the center of the upper space. For example, the waveguide coupler located in the lower space may have a diameter of about 10.4 mm and a height of 6.8 mm. In addition, heights h_{d} and hᵤ of the lower space and the upper space may each be formed to be 10.0 mm. A thickness of the separator partitioning the lower space and the upper space of the power feeding unit 110 may be 1.0 mm, and a gap between the separator and the inner periphery of the power feeding unit 110 may each be 5.7 mm.

As another example, the electromagnetic wave may be propagated in the form of the concentric wave outward from the center. To this end, the power feeding unit may not be partitioned into the lower space and the upper space, and the inside of the power feeding unit has a single space forming a single plane. In such a case, the waveguide coupler receiving the electromagnetic wave may be located at a single space center inside the power feeding unit 110, and an electromagnetic wave which forms a concentric circle to spread in an outside direction from the center may be formed. Further, the absorber may be located at an outer portion of the reconfigurable metasurface antenna 100, which forms the concentric circle and absorbs the electromagnetic wave which spreads in the outer direction.

The inclined portion of the inner reflection unit of the lower space may have a height of 6.0 mm and a length of 8.4 mm. The inclined portion of the inner reflection unit of the upper space may have a height of 4.8 mm and a length of 7.5 mm.

In an embodiment of the present disclosure, it is described focusing on the assumption that the inner reflection units of the lower space and the upper space are formed differently, but the inner reflection units of the lower space and the upper space may also be formed to have the same length, the same height, and the same angle of inclination. Further, the height and length may vary depending on the frequency range utilized and the number of center frequencies.

The power feeding unit 110 may be partitioned into the lower space and the upper space by the separator, and the waveguide coupler located at the center of the lower space may couple the electromagnetic waves fed through the cable without reflection to propagate the electromagnetic waves from the center of the lower space to the outside at a uniform density in the form of the concentric wave.

The electromagnetic waves propagated by the waveguide coupler are reflected by the inner reflection unit formed on the outer periphery of the lower space and transmitted to the upper space, and the electromagnetic waves transmitted to the upper space are propagated from the outside to the center in the form of the concentric wave and collected at the RF absorber formed at the center of the upper space.

In other words, the electromagnetic waves are propagated internally in the form of the concentric wave based on the center of the antenna, and this concentric wave form may play an important role in beam steering of the reconfigurable metasurface antenna.

The electromagnetic wave traveling in the circular shape is the sum of plane waves traveling in all directions, and among these, the variable metasurface unit 120 at the top may extract only components that make up the beam in the direction to be steered.

The variable metasurface unit 120 is disposed on the upper part of the power feeding unit 110. As described above, the top surface of the power feeding unit 110 and the bottom surface of the variable metasurface unit 120 may be disposed to contact each other. Accordingly, the electromagnetic waves that are collected and travel from the top surface of the power feeding unit 110 to the center may interact with the activated unit radiators of the variable metasurface unit 120 and emit some energy to the outside. The phase and polarization components of the electromagnetic waves emitted from the variable metasurface unit 120 may vary depending on the combination of unit radiators that are activated. That is, the phase and polarization components of the electromagnetic waves emitted from the variable metasurface unit 120 may vary depending on the location, shape, and angle of the activated unit radiator.

When the electromagnetic waves inside the power feeding unit 110 pass through a deactivated unit radiator of the variable metasurface unit 120, the electromagnetic wave may proceed in the direction in which the electromagnetic wave were traveling without any special interaction.

The variable metasurface unit 120 is located on the upper part of the power feeding unit 110 and is a means for receiving the electromagnetic waves from the power feeder 110 and radiating them to the outside.

FIG. 5 shows a part of a cross-sectional view of the variable metasurface unit 120 according to the first embodiment of the present disclosure. In the variable metasurface unit 120, the electromagnetic waves fed through an optical waveguide 520 meet a pattern (i.e., each unit radiator) formed on the bottom of the variable metasurface unit 120, and interact with the pattern, and as a result, a radiation pattern and efficiency of each unit radiator are determined. Here, each of the bias line and each unit radiator may be formed by using copper foils.

That is, a top 530 of the variable metasurface unit 120 is shown in FIG. 7, and a bottom 540 is shown in FIG. 6.

The variable metasurface unit 120 includes a plurality of unit radiators. Here, the plurality of unit radiators may be arranged in the form of a sunflower array, as illustrated in FIG. 6.

In more detail, the plurality of unit radiators of the variable metasurface unit 120 may be formed on the bottom of the variable metasurface unit 120. In addition, each of the plurality of unit radiators may be formed in a circular ring shape, as shown in FIG. 7.

As shown in FIG. 7, as each unit radiator is formed in a circular ring shape, an isolated area (for convenience, referred to as an inner center) 705 may be formed at the inner center of the unit radiator. An electrical signal that controls whether each unit radiator is activated may be provided through a via hole penetrating from the inner center of the unit radiator to the top surface. The diameter of each unit radiator may be, for example, 9.3 mm.

In an embodiment of the present disclosure, it is described that the diameter of each unit radiator is limited to 9.3 mm, but the diameter of each unit radiator may be changed depending on the frequency at which the antenna is utilized. In addition, the diameter of each unit radiator may be modified in inverse proportion to the dielectric constant of the PCB board used in the reconfigurable metasurface antenna. Based on the most commonly used FR4 substrate, if the antenna utilization frequency is, for example, Ku band, 12 to 18 GHz, the diameter of each unit radiator may vary in size from 1 mm to 12 mm. Further, when the diameter of each unit radiator is 1 mm to 12 mm, the size of the circular ring-shaped gap of each unit radiator may be 0.1 to 11 mm. Here, the gap represents the difference between the outer radius of the circular ring shape of each unit radiator and the radius of the isolated area (i.e., the inner center).

Each unit radiator includes at least one active electronic device (active device) 710 because its electromagnetic properties, such as resonance, must be modulated according to the electrical signal. Here, the active electronic device 710 may be a PIN diode or a varactor diode.

As shown in FIG. 7, the plurality of unit radiators are each formed in the shape of a circular ring, and the current flow may be turned on or off by the potential difference between the inside and outside of the plurality of unit radiators by the active electronic device.

The active electronic device may serve to connect electrical signals or change the phase of electromagnetic waves. The shape of the variable metasurface unit 120 may vary depending on desired characteristics by the active electronic device. For example, the variable metasurface unit 120 may have various shapes such as square shape, dumbbell shape, circle shape, triangle shape, bow tie shape, oval shape, etc.

FIG. 8 is an enlarged view of a portion of the top of the variable metasurface unit 120. As shown in FIG. 8, a plurality of bias lines (electrical signal lines) are formed on the top of the variable metasurface unit 120, and the electric signal applied through each bias line may be transmitted to each unit radiator formed on the bottom through the via hole.

One end of the plurality of bias lines is bundled and connected to a connector, and the electrical signal may be supplied through the connector. Additionally, other ends of the plurality of bias lines are each connected to via holes connected to each unit radiator so as to affect electromagnetic waves interacting with each unit radiator.

That is, each of the plurality of unit radiators may be connected to each bias line formed on the top of the variable metasurface unit 120 through the via hole at the center. That is, each unit radiator may be connected to a bias line formed on the top of the variable metasurface unit 120 through the via hole formed at the center of each unit radiator, and the electrical signal applied through the bias line may be transmitted to each unit radiator through the via hole.

According to the electric signal transmitted through the via hole, a potential difference may be generated inside and outside each unit radiator formed in the circular ring shape, and the current flow may be turned on or off by the active electronic device formed to connect the inner center of each unit radiator formed in the circular ring shape and the outside.

In addition, the bias line for electronic control of each unit radiator may be formed to be perpendicular to a virtual direction line connecting the via formed at the center of each unit radiator and the center of the variable metasurface unit to minimize the effect on the interaction between the supplied electromagnetic wave and each unit radiator (see FIG. 9).

As shown in FIG. 9, the virtual direction line is a virtual line that connects the via hole formed at the center of each unit radiator and the center of the variable metasurface unit, and may also be formed differently depending on the position of each unit radiator. The virtual direction line is only for illustration purposes and is not a line formed on the actual variable metasurface unit 120.

For example, it is assumed that the virtual direction line of the unit radiator is as shown in FIG. 9. A portion of each bias line connected to the via hole communicating with the center of each unit radiator may be bent to be perpendicular to the virtual direction line (i.e., 90 degrees) and connected to the via hole. In this way, there is an advantage in minimizing interference by connecting the bias lines to vias so that a portion of each bias line is perpendicular to the virtual direction line corresponding to each unit radiator.

Each bias line in the portion corresponding to the area of each unit radiator is bent perpendicular to each unit radiator and connected to the via, and after extending out of the area of each unit radiator, the bias line is bent outward and connected to the connector.

For example, assuming that the embodiment of the reconfigurable metasurface antenna is an antenna operating in the Ku band that may be used for satellite communication, the line width of each bias line may be formed between 0.1 mm and 0.5 mm.

Each unit radiator of the variable metasurface unit 120 is positioned as a sunflower array, and the position may be determined as in Equation 1:

$$x = \sqrt{i} \times ( ratio ) \times {λ}_{0} \times cos ( {α}_{g} \times i ) \\ y = \sqrt{i} \times ( ratio ) \times {λ}_{0} \times sin ( {α}_{g} \times i ) \qquad [ Equation 1 ]$$

wherein, i represents the index of each unit radiator, α_{g} represents a golden angle (π(3−\sqrt{5})≈137.5 represents the center frequency wavelength, a ratio represents the ratio to the spacing distance between each unit radiator. In an embodiment of the present disclosure, it is assumed that the ratio is 0.35. However, the ratio is not necessarily limited to a fixed value of 0.35, and the size of the ratio is 0.1 or more and may naturally be modified depending on the number or size of each unit radiator. That is, the size of the ratio may be changed depending on the range of the index i of each unit radiator.

The active electronic device (PIN diode) included in each unit radiator of the variable metasurface unit 120 is located in a place where the active electronic device may respond sensitively to current flow, but in an embodiment of the present disclosure, the active electronic device of each unit radiator may be positioned to face the center of the variable metasurface unit 120.

The variable metasurface unit 120 may be created by setting the center of the variable metasurface unit 120 to the origin (0,0) and excluding the first few (i=1 to 5).

Two-dimensional beam steering is possible according to electrical signal control to each unit radiator of the variable metasurface unit formed as described above.

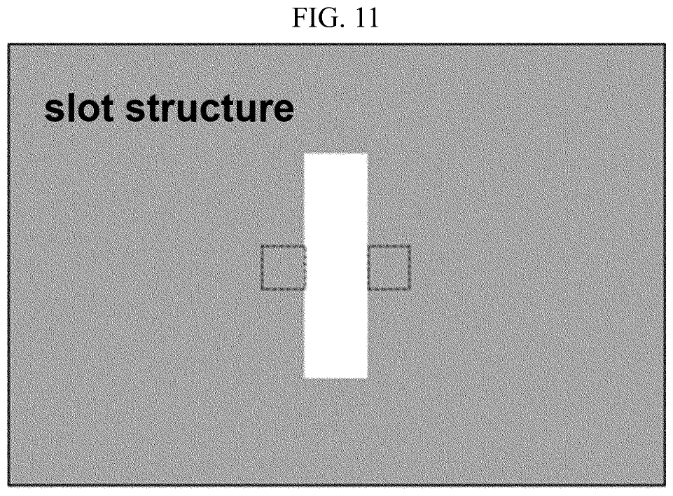

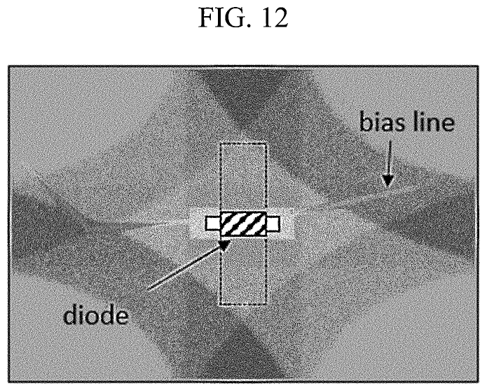

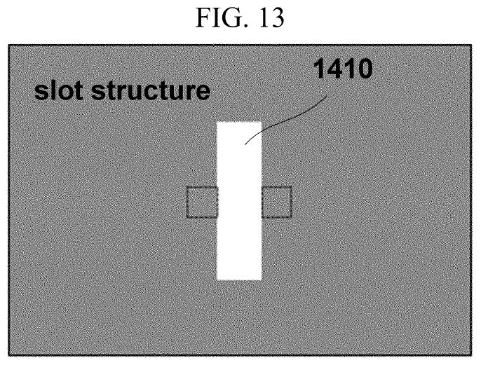

Referring to FIGS. 10 to 12, a metallic substrate 1030 may be positioned on the variable metasurface unit 120 according to a second embodiment of the present disclosure. On this metallic substrate 1030, a rectangular metal slot structure may be formed as shown in FIG. 11. Further, as shown in FIG. 12, each unit radiator may be formed on the bottom of the variable metasurface unit 120 corresponding to each metal slot structure, and the active electronic device may be formed in each unit radiator. Unlike the first embodiment, as the metallic substrate is positioned on the top of the variable metasurface unit 120, and the rectangular metal slot is formed, the bias line may be formed on the same surface as each unit radiator formed on the bottom 540 of the variable metasurface unit 120 (see FIG. 13).

As shown in FIGS. 11 and 12, each unit radiator may be positioned on the bottom of the variable metasurface unit 120 corresponding to the metal slot structure. The unit radiator according to the second embodiment may be formed at a location corresponding to the metal slot structure formed on the top, and each unit radiator may be formed in a rectangular shape, and the active electronic device (PIN diode) in the rectangular shape may be positioned at a location corresponding to the center of the metal slot structure. Further, the active electronic device (PIN diode) may be positioned on the same surface where the bias line is formed, and whether the active electronic device is activated may be determined according to the electrical signal provided through the bias line. Each unit radiator may be connected to each bias line formed on the bottom of the variable metasurface unit, and the electrical signal for activation may be transmitted through each bias line. As shown in FIG. 12, the metal slot may be formed on the top of the variable metasurface unit according to the second embodiment, and individual radiation patterns of each unit radiator may be determined by the metal slot.

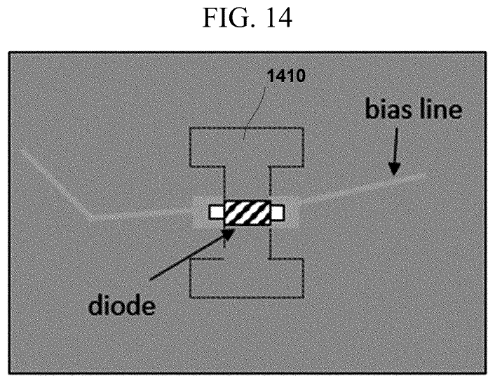

As shown in FIGS. 13 and 14, a form of a slot formed on the top of the variable metasurface unit according to a third embodiment may also be implemented in a metal I-shaped slot structure. Each unit radiator 1410 formed in the rectangular shape on the bottom of the variable metasurface unit may be formed to correspond to a location of the metal I-shaped slot structure. Further, each unit radiator 1410 may include the active electronic device, and may receive the electrical signal through the bias line. Since the form of the slot is just different, and the remaining configurations are the same compared to the second embodiment, a redundant description is omitted.

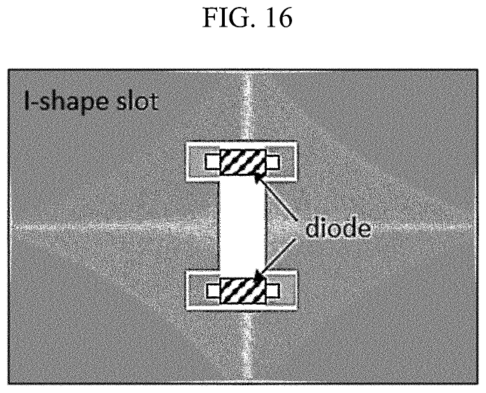

According to a fourth embodiment of the present disclosure, the metallic substrate may be positioned on the top of the variable metasurface unit, and an i-shaped slot may be formed on the metallic substrate, and each unit radiator 1530 may be positioned in the metal I-shaped slot (see FIG. 16).

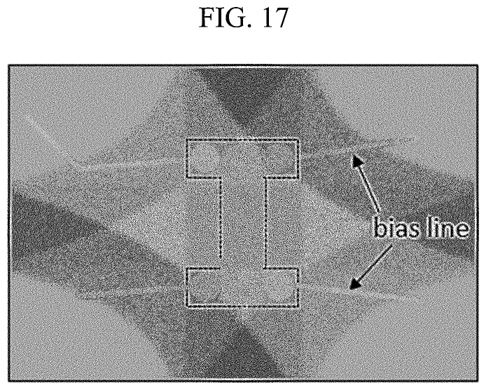

As each unit radiator is positioned in the metal I-shaped slot, the bias line and the via hole for transmitting the electrical signal to the each unit radiator may be formed on the bottom of the variable metasurface unit to correspond to the location of each unit radiator (see FIG. 17). As a result, the electrical signal supplied through the bias line formed on the bottom of the variable metasurface unit may be transmitted to each unit radiator positioned on the top of the variable metasurface unit through the via hole.

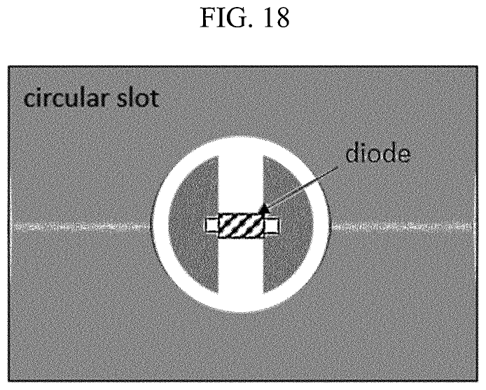

According to a fifth embodiment of the present disclosure, as shown in FIG. 18, the metal slot formed on the top of the variable metasurface unit may be formed in the circular shape, and each unit radiator may be positioned in a corresponding circular metal slot. The active electronic device may be positioned in each unit radiator, and similar to the fourth embodiment, as each unit radiator is formed in the circular metal slot formed on the top of the variable metasurface unit, the electrical signal to the active electronic device included in each unit radiator may be transmitted through the bias line formed on the bottom through the via hole.

As described with reference to the first to third embodiments, each unit radiator according to an embodiment of the present disclosure may be formed on the bottom of the variable metasurface unit. In such a case, since each unit radiator is formed on the bottom of the variable metasurface unit, fed electromagnetic waves may first meet each unit radiator, and then may be radiated outward through a substrate dielectric layer.

In addition, as described with reference to the fourth and fifth embodiments, when each unit radiator is formed on the top of the variable metasurface unit, the fed electromagnetic waves may be radiated outward by interacting with each unit radiator of the top of the variable metasurface unit after passing through the substrate dielectric layer.

As described above, the shape of each unit radiator may be variously formed like a simple rectangular shape, an I shape, a circular shape, etc., and more various geometries may be formed through a combination thereof. Further, each unit radiator may be formed not only in different shapes but also in different sizes.

In addition, whether the respective unit radiators are individually activated as the radiators may be determined by the electrical signal, and the electrical signal may position the active electronic device on the top or the bottom of the variable metasurface unit, and the electrical signal to the active electronic device may be transmitted through the bias line formed on the same surface or also transmitted to the other surface through the via hole.

An angle at which the bias lines begin to stretch out of each unit radiator may be adjusted to adjust resonance characteristics of each unit radiator.

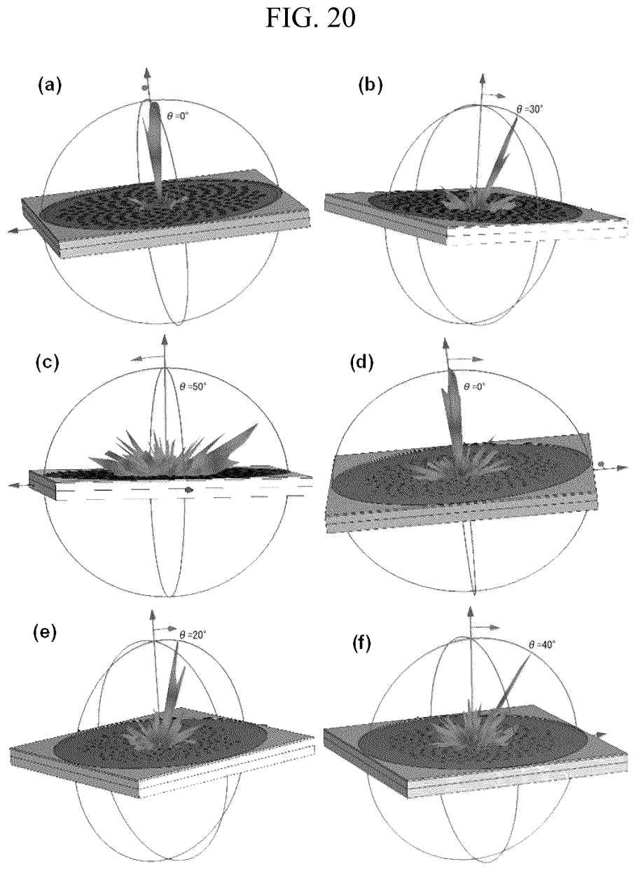

FIG. 20 is a diagram showing a result in which beam steering of the variable metasurface unit 120 varies depending on switching of each unit radiator. The reconfigurable metasurface antenna is capable of free beam steering for satellite communication uplink, and if the structures are changed to fit the 14.25 GHz band, free beam steering is also possible for downlink.

In addition, the performance of the reconfigurable metasurface antenna may vary depending on the number of each unit radiator forming the metasurface and the area of the antenna radiation surface. The intensity of radiated electromagnetic wave energy can be predicted based on dipole modeling, and the energy intensity of the steering beam and the number of each unit radiator have a proportional relationship.

For example, the antenna gain may increase in size in proportion to various elements such as the number of units, an antenna radius, etc.

Hereinabove, the present disclosure has been described with reference to the embodiments thereof. It will be understood by those skilled in the art to which the present disclosure pertains that the present disclosure may be implemented in a modified form without departing from essential characteristics of the present disclosure. Therefore, the embodiments disclosed herein should be considered in an illustrative aspect rather than a restrictive aspect. The scope of the present disclosure is defined by the appended claims rather than the foregoing description, and all differences within the scope equivalent to the claims should be interpreted to fall within the present disclosure.

1. A reconfigurable metasurface antenna, comprising:
a power feeding unit receiving and propagating electromagnetic waves in a form of a concentric wave; and
a variable metasurface unit positioned at an upper part of the power feeding unit, having a plurality of unit radiators, and radiating the electromagnetic waves transmitted from the power feeding unit according to a combination of activated unit radiators among the plurality of unit radiators.

2. The reconfigurable metasurface antenna of claim 1, wherein the plurality of unit radiators are formed in a circular ring shape, a metal slot shape, a metal I-shaped slot shape, and a circular metal slot shape, respectively, or formed in different shapes or in a combination of the shapes, and formed in different sizes, and
each of the plurality of unit radiators is formed on top or bottom of the variable metasurface unit.

3. The reconfigurable metasurface antenna of claim 2, wherein each of the plurality of unit radiators includes at least one active electronic device, and the active electronic device is formed on the same surface as or an opposite surface to a bias line, and when the active electronic device is formed on the opposite surface, each unit radiator is connected to the bias line through a via hole.

4. The reconfigurable metasurface antenna of claim 3, wherein when the plurality of unit radiators are formed in the circular ring shape, an inner center separated by the circular ring shape is connected to outside by the active electronic device, and
the via hole for transmitting an electrical signal for controlling whether the plurality of unit radiators are activated is formed at the inner center of the plurality of unit radiators.

5. The reconfigurable metasurface antenna of claim 4, wherein the active electronic device is disposed to face a center of the variable metasurface unit.

6. The reconfigurable metasurface antenna of claim 4, wherein a plurality of bias lines are formed on the top of the variable metasurface unit, and
one end of each bias line is connected to each unit radiator through the via hole.

7. The reconfigurable metasurface antenna of claim 6, wherein a portion of each bias line connected to each unit radiator through the via hole is formed perpendicular to a virtual direction line of each unit radiator.

8. The reconfigurable metasurface antenna of claim 7, wherein the virtual direction line is a virtual line connecting the center of the variable metasurface unit and the via hole of each unit radiator.

9. The reconfigurable metasurface antenna of claim 3, wherein the other end of each bias line is connected to a connector applying an electrical signal, and
whether each unit radiator is activated is determined by the electrical signal applied through the bias line.

10. The reconfigurable metasurface antenna of claim 1, wherein locations of the plurality of unit radiators are determined by following equation:
$$x = \sqrt{i} \times ( ratio ) \times {λ}_{0} \times cos ( {α}_{g} \times i ) \\ y = \sqrt{i} \times ( ratio ) \times {λ}_{0} \times sin ( {α}_{g} \times i )$$
wherein, i represents index of each unit radiator, α_{g} represents a golden angle (π(3−\sqrt{5})=137.5°), λ₀ represents a center frequency wavelength, ratio represents a ratio to a spacing distance between each unit radiator.

11. The reconfigurable metasurface antenna of claim 1, wherein the power feeding unit has a lower space and an upper space partitioned by a separator formed therein, or has a single space forming a single plane without the separator, and when inside is partitioned into the lower space and the upper space by the separator, a waveguide coupler receiving the electromagnetic waves is positioned at a center of the lower space, and an RF absorber absorbing the electromagnetic waves is positioned at a center of the upper space and the electromagnetic waves are reflected to the upper space from the lower space.

12. The reconfigurable metasurface antenna of claim 11, wherein the electromagnetic waves are propagated in different directions in the lower space and the upper space.

13. The reconfigurable metasurface antenna of claim 11, wherein when the power feeding unit has the single space without the separator, the waveguide coupler receiving the electromagnetic waves is positioned at a center of internal space and electromagnetic waves which spread outward from the center while forming a concentric circle are formed, and an absorber absorbing electromagnetic waves which spread outward while forming the concentric circle is positioned to surround the reconfigurable metasurface antenna outside the waveguide.

14. A reconfigurable metasurface antenna, comprising:
a power feeding unit receiving and propagating electromagnetic waves in a form of a concentric wave; and
a variable metasurface unit positioned at an upper part of the power feeding unit, and having a plurality of unit radiators, in which beam steering of the electromagnetic waves varies according to a combination of activated unit radiators among the plurality of unit radiators,
wherein each of the plurality of unit radiators includes at least one active electronic device, and whether each unit radiator is activated is determined by the active electronic device.
